(19) United States
(12) Patent Application Publication
(10) Pub. No.: US 2013/0266977 A1
(43) Pub. Date: Oct. 10, 2013

(54) METHODS AND SYSTEMS FOR DETECTION OF MICROBES

(71) Applicants: Ralph Mitchell, Cambridge, MA (US); Nick Konkol, Cambridge, MA (US); Christopher J. McNamara, Groton, MA (US); Marc Mittelman, Canton, MA (US); Michael Laine, Newburyport, MA (US)

(72) Inventors: Ralph Mitchell, Cambridge, MA (US); Nick Konkol, Cambridge, MA (US); Christopher J. McNamara, Groton, MA (US); Marc Mittelman, Canton, MA (US); Michael Laine, Newburyport, MA (US)

(73) Assignee: PRESIDENT AND FELLOWS OF HARVARD COLLEGE, Cambridge, MA (US)

(21) Appl. No.: 13/579,467

(22) PCT Filed: Feb. 16, 2011
(86) PCT No.: PCT/US11/25019

§ 371 Date: Jun. 28, 2013

Related U.S. Application Data
(60) Provisional application No. 61/304,819, filed on Feb. 16, 2010.

(51) Int. Cl. G01N 21/64

(52) U.S. Cl. CPC G01N 21/6486
USPC 435/21; 435/18; 435/19; 435/24; 435/25; 435/27; 435/288.7

(57) ABSTRACT

Provided herein are methods, test units, systems, assays and kits for qualitative and/or quantitative detection of microorganisms or microbes. Some aspects of the invention utilize a test strip comprising a test area and a self-calibrating control area that permits quantitative measurements to be obtained rapidly at the test site. The test strip is ready-to-use and does not require any preparation. The present systems and methods provide valuable tools for sensitive early detection of microbial contamination.

### CROSS-REFERENCE TO RELATED APPLICATIONS

This International application paragraphs the benefit of priority under 35 U.S.C. §119(e) of U.S. Provisional Application No. 61/304,819, filed Feb. 16, 2010, the contents of which are incorporated herein by reference in their entirety.

### FIELD OF THE INVENTION

The invention relates to methods, units, systems and kits for detection of microbes in a variety of samples, for example, environmental samples, food products, plant materials, building construction materials, and biological samples.

### BACKGROUND OF THE INVENTION

Microbial infections can be a serious health hazard. Agricultural and food products, industrial materials, surfaces in buildings and medical devices also are susceptible to contamination and/or deterioration by fungi and/or bacteria. For example, cultural heritage materials such as paintings, statues, and books can be damaged by fungal contamination and growth; a high spore count is a key indicator of fungal infection and contamination.

Most tests for fungal spore contamination are based on the cultivation of spores, and require incubation times of 24-48 hours. Other available spore assays use methods other than growth media for detection, but still require germination of the spores before they can be detected. The delay caused by the need for germination and growth can have severe consequences. For example, a 24- or 48-hour delay in testing of medical devices or fluids (such as blood) for fungal contamination or infection may be fatal. Likewise, in food processing, confirming the presence of a fungal contamination problem one or two days after testing can result in significant losses.

The use of test strips or cards which contain a detectable moiety for detecting the presence of microorganisms or microbes is known (1, 2). However, these established methods for detecting microorganisms or microbes such as fungi or bacteria in a sample involve culturing microbes from an infected area, and transferring the microbes to the surface of the test strip in solution, or via an inoculation loop or similar device. Commercial products have been utilized for visual identification of Candida in clinical isolates, as described in Freydiere and Guinet (3). Based on the source of the biological material, a positive signal (e.g., fluorescence observed visually under UV light) indicates the presence of Candida species. However, these commercial products still require primary isolation and culture of the microorganisms before detection. While the use of a detectable moiety to detect and quantify fungal biomass is described in the U.S. Pat. No. 6,372,446 (4), the methods and products disclosed therein do not account for background signal that could skew the signal data from a test sample. Correction of background signal is particularly important if the presence of microbes is in minute quantities.

Planar slides and cards have been used to perform diagnostic tests, including blood, urine and sputum chemistry tests, as well as blood typing. Similar layered devices for detecting the presence of microorganisms have been described. For example, U.S. Pat. Nos. 5,096,668 and 5,411,893 (5, 6) disclose a diagnostic test slide for detecting the presence of microorganisms, which comprises a plastic film with a coating that includes a carrier and a reagent, enzymes or metabolites. The plastic film can further include fluorogenic substrates. However, the '668 and '893 patents do not teach methods to take into account background signal during test analysis. Although these diagnostic test slides can determine whether microbes are present in a sample, they cannot quantitatively measure the amount of detected microbes in the sample, which could be essential for designing an effective treatment strategy. As such, there is still a strong need in the art for development of rapid and quantitative detection of fungi and/or bacteria in order to prevent deleterious consequences of contamination with these microbes.

### SUMMARY OF THE INVENTION

Provided herein are methods, test units, systems, and kits for determination of microbes, e.g., fungi and bacteria, in a sample or on a sample surface. Examples of a sample include, but are not limited to, food, an agricultural product, building material, cultural heritage material, and/or biomedical device surface. In some embodiments, biological samples can also be assayed using various embodiments of the invention.

In one aspect, the invention provides a test unit for determination of microbial contamination, including fungi and bacteria. The test unit includes a base support having disposed thereon (a) at least one test area containing one or more targeting molecules comprising a microbial enzyme substrate conjugated with a detectable label, and (b) at least one control area containing at least one known amount of the detectable label in an unconjugated state.

In some embodiments, the microbial enzyme substrate is N-acetyl-β-D-glucosaminide, N-acetyl-β-D-glucosamine, N,N′-diacetyl-β-D-chitobioside or β-D-N,N′,N″-triacetylchitotriose. In some embodiments, the detectable label emits light when it is in the unconjugated state. Examples of the detectable label include, but are not limited to, a chemiluminescent, chromogenic or fluorescent compound. In one embodiment, the fluorescent compound is 4-methyl-umbelliferone.

In certain embodiments, the at least one test area comprises at least two different targeting molecules comprising a microbial enzyme substrate conjugated with a detectable label. In some embodiments, different enzyme substrates specific for the types of microbes being detected can be used. In other embodiments, the at least one test area comprises a plurality of test sub-areas containing a targeting molecule, the targeting molecule comprising a microbial enzyme substrate conjugated with a detectable label. In such embodiments, the targeting molecule can be the same or different in each test sub-area. The use of multiple enzyme substrate-detectable label conjugates allows different types of microorganisms to be detected simultaneously.

In accordance with the invention, there is at least one control area disposed on the base support. In one aspect, the control area acts as a negative control by detecting background emissions present in the sample. In another aspect, the control area can be used to provide calibration standards, i.e., by providing one or more known quantities of the light-emitting compound that can be used as a basis for comparison with the quantity of light emitted from the compound in the test area. In one embodiment, the at least one control area comprises a plurality of sub-areas containing a known amount of the detectable label, e.g., in a range of concentrations. In such embodiments, the known amount of the detectable label in each sub-area can be the same or different. If more than one enzyme substrate-detectable label conjugate is used in the test area(s), then the control area can include known amounts of each of the detectable labels used in the test area(s).

In further embodiments, the test unit can comprise an identification element, e.g., to encode and/or store data such as sample information, test unit information, and detection condition. Exemplary identification element can be, but is not limited to, a bar code, a radio frequency identification label, a microchip or a computer-readable tag.

In one embodiment, the test unit of the invention is a test strip.

Another aspect of the invention provides methods for determining microbes in a sample or on a sample surface, e.g., using a test unit of the invention. The method includes (a) contacting a sample to be detected with the test unit described herein, and (b) detecting a signal emitted from the unconjugated detectable labels in the test and control areas of the test unit of step (a), wherein the detectable label of the targeting molecules is released from the microbial enzyme substrate and becomes unconjugated in the presence of microbes.

In some embodiments, the contacting can be on a solid surface, in liquid or in air. In certain embodiments, the method requires no suspension of the sample in a fluid prior to the contacting. In additional embodiments, the method requires no addition of a reagent to the test unit prior to or after the contacting, or culturing of microbes collected from the sample prior to the contacting. Accordingly, the contacting can be also in situ.

After contacting the sample with the test unit, signals emitted from the test and control areas can be detected, e.g., with a light-detecting device, wherein the signal can be light with a wavelength selected from an infra-red, visible or ultraviolet range.

If necessary or desired, the test unit can be briefly incubated before detection, in order to allow time for enzymes present in the microorganisms to react with the enzyme substrates in the test unit, and cleave the detectable label from the substrate. In some embodiments, such incubation period can vary between about 5 minutes and about 30 minutes, or between about 10 minutes and 15 minutes.

In various embodiments, the methods can further comprise a step of determining the amount of microbes by comparing the signal of the test area with the signal of the control area.

A further aspect of the invention provides a system for qualitative or quantitative detection of microbial contamination, including fungi and bacteria. The system includes (a) a sample module configured to receive at least one test unit described herein; (b) a light-detecting device configured to detect light emitted from the test and control areas; (c) a computing module adapted to compare the light emission data of the test area with that of the control area; and (d) a display module for displaying an output from the computing module, wherein the output includes an indicator of whether any microbe was identified, the detected microbe, and/or the amount of the detected microbe.

The light emitted from the free (unconjugated) detectable label present on the test unit can be detected and measured using a light-detecting device comprising a light emitter and light sensor, e.g., a photoelectric cell. The data are analyzed by a data processor, and the signal is assigned with a numeric intensity based on pre-established standards, some of which can be included in the control area, thereby quantifying the amount of detectable label. The amount of free detectable label observed in the test area correlates directly with the quantity of the microorganisms in the sample or on the sample surface.

In some embodiments, the system can further comprise a temperature sensor and/or a relative humidity sensor. In additional embodiments, the system can comprise a module for transmitting data. Hand-held, desktop, or wall-mounted devices with fully integrated capabilities to accommodate sampling of a single or multiple strips can be utilized for automated data acquisition, storage, and/or retrieval. The system and method can be used for detection of microbial contamination on solid surfaces, in liquids, and/or in air.

Kits that can be used for determination of microbes in a sample or on its surface are also provided herein. In one embodiment, the kit includes a plurality of the test units as described herein, and an instruction manual. In some embodiments, the plurality of the test units can be embodied in a continuous roll or discrete test units. In various embodiments, the kits can further comprise a portable light-detecting device, e.g., a hand-held spectrometer.

The methods, test units, systems and kits of the invention can be used for rapid, early detection of microbial contamination in a sample of interest. Germination and/or culturing of the microbes is not necessary, therefore the assay can be completed in a short time, typically less than one hour.

### BRIEF DESCRIPTION OF THE DRAWINGS

FIG. 1 is a schematic diagram showing one embodiment of the invention. One embodiment of the test units disclosed herein is a test strip 100 having a test area 104, a control area 106 and an identification area 108. After contact with the sample, the test strip 100 can be subjected to a detector 110, which detects light emitted from the test and control areas. The signals obtained by the detector are then transmitted to the data processor 112, which analyzes the data from the test strip and provides a read-out. One embodiment of the systems 114 is thus also provided herein.

FIG. 2 is a graph showing the correlation between fluorescence and the quantity of fungal spores present on a sample surface. The intensity of fluorescence observed directly correlates with the number of spores.

### DETAILED DESCRIPTION OF THE INVENTION

Embodiments of the invention provide methods, test units, kits or assays, and systems for determining the presence or absence of microbes in a sample or on a sample surface. As used herein, the phrase “determining the presence or absence of microbes” refers to detecting the existence of microbes in a sample or on a sample surface. The phrase “determining the presence or absence of microbes” can also encompass measuring the quantity of microbes in a sample or on a sample surface. The term “determining the presence or absence of microbes” can further include identifying the types and/or species of microbes.

### Test Units of the Invention

One aspect of the invention provides test units for determining the presence or absence of microbes. In embodiments of the invention, the test unit includes a base support having disposed thereon (i) at least one test area containing one or more targeting molecules comprising a microbial enzyme substrate conjugated with a detectable label, and (ii) at least one control area containing at least one known amount of the detectable label in an unconjugated state.

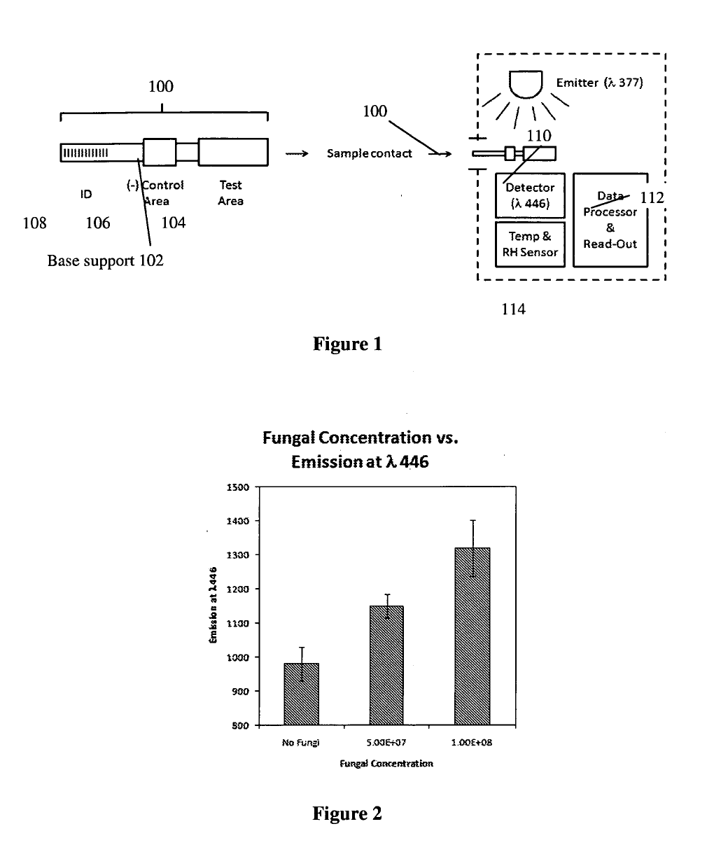

FIG. 1 illustrates a diagrammatic top-view of a test unit in accordance with one or more embodiments of the invention. As shown in FIG. 1, one embodiment of the test unit is a test strip 100, which includes a base support 102 having disposed thereon a test area 104 and a control area 106. The test area will indicate a positive signal when in contact with microbes, while the control area will be used to account for background emission and/or indicate a signal corresponding to a known amount of the signal-emitting compound for comparison.

In embodiments of the invention, the base support 102 functions as a support or receptacle to hold the test and control areas. Thus, the base support 102 should be inert, i.e., no biological or chemical activity with reagents in the test or control areas or samples to be tested, and thus cannot influence the test results. Inert materials can be absorbent or non-absorbent. Examples of inert materials that can be used for the base support include, but are not limited to, glass (such as a glass slide), plastic, polymer, cardboard, paper, cellulose-based materials and nitrocellulose membranes. In one embodiment, the base support comprises an inert polymer or plastic, e.g., polyethylene, polyester, polyvinyl chloride, polyethylene terephthalate, polyethylene terephthalate glycol, cellulose triacetate, and polycarbonate, polystyrene, polypropylene, acrylic, silicone, polyurethane, halogenated plastic, and any combination thereof. In one embodiment, the base support is a composite of multiple inert materials. In some embodiments, the base support comprises polycarbonate. In another embodiment, the base support is made of polycarbonate.

Cellulose-based materials can also be used in the base support. For example, when paper material is utilized in forming the base support, it can be selected from, but not limited to, cardboard, absorbent paper, plastic-backed paper, membrane covered absorbent paper, and porous membrane-covered absorbent paper.

The base support can take any shape. For example, the base support can be of any planar shape such as a circle, a square, a rectangle, a triangle or any irregular shape. In one embodiment, the base support is of a rectangular shape, e.g., in the form of a “strip,” which is understood to mean a planar, elongated shape. The strip shape is convenient, easy to manipulate, and easily read by a detection device. In such embodiments, the base support can have surface dimensions of about 0.5 cm to about 5 cm in width, and about 1 cm to about 20 cm in length. In one embodiment, the base support can have surface dimensions of about 1 cm×6 cm. The base support can has a thickness of from about 0.5 to about 5 mm. In one embodiment, the base support has a thickness of about 2 mm. Depending upon the desired throughput and shape of the test unit, as well as types of samples to be tested, the base support can vary in size and be defined in different dimensions.

In one embodiment, the base support can be a planar disk. In other embodiments, the base support can have a curved surface, e.g., a dipstick. Alternatively, a continuous roll can be utilized rather than discrete test strips, on which the test and control areas are in the form of continuous lines or a series of spots.

The test or control area can be positioned anywhere on the base support. In some embodiments, the test area 104 or the control area 106 can be positioned in proximity to or at the edge of the base support. For example, as shown in FIG. 1, the test area 104 can be positioned in proximity to or at the end of the base support. In other embodiments, the test area 104 or the control area 106 can be positioned away from the edge of the base support. The test area 104 and the control area 106 can be arranged in any configurations on the base support. However, the test area 104 or the control area 106 should be spaced apart on the base support 102 such that the signals from each test or control area cannot interfere with each other during detecting and/or measuring the signals from test and control areas.

### Test Area of the Test Unit

In accordance with the invention, the base support has at least one test area 104 and at least one control area 106 disposed thereon. The test area 104 contains one or more targeting molecules comprising a microbial enzyme substrate conjugated with a detectable label (termed as “enzyme substrate-label conjugate” throughout the application). The microbial enzyme substrate is a substrate specific for types of microbes to be detected, and it is selected depending upon what enzymes the microbes possess. For example, N-acetyl-beta-D-glucosamine can be a microbial enzyme substrate for detection of the beta-N-acetylhexosaminidase activity of fungi such as Aspergillus niger. Accordingly, microbial enzyme substrates utilized in the targeting molecules will depend upon the types of microorganisms or microbes, e.g., bacteria or fungi, to be detected.

In some embodiments, the test units can be used to detect or quantify bacteria in a sample or on a sample surface. As such, the microbial enzyme substrates employed in the targeting molecules can comprise any substrates for bacterial enzymes, such as cytochrome oxidase, beta lactamase, L-aniline amino peptidase, catalase, coagulase, urease, glucuronidase, ortho-nitrophenyl galactosidase, phosphatase, β-glucosidase, C₈ esterase, N-acetyl-β,D-galactosamidase, pyrrolidoxyl aminopeptidase, or any enzymes present in bacteria. Substrates for these enzymes are well known to those skilled in the art. A skilled artisan can determine appropriate substrates for enzymes based on their names, because the suffix “-ase” is usually added to the name of its substrate or the type of reaction. For example, glucuronidases are enzymes that break down complex carbohydrates, such as glucuronic acid or associated compounds, and catalyze hydrolysis of glucuronic acid. Hence, a substrate can be determined readily by a skilled artisan for a known microbial enzyme.

In certain embodiments, the test units can be used to detect and/or quantify fungi in a sample or on a sample surface. In such embodiment, the targeting molecules of the invention comprises a substrate specific for a fungal enzyme, for example, chitinase, phosphatase, esterase, α-glucosidase, β-glucosidase, N-acetyl-β-D-galactosaminidase, urease, aminopeptidase, proteases or any enzymes present in yeasts and molds. In one embodiment, the microbial enzyme substrate is a substrate for chitinase. Without limitation, a chitinase substrate can be N-acetyl-β-D-glucosaminide, N-acetyl-β-D-glucosamine, N,N′-diacetyl-β-D-chitobioside or β-D-N,N′,N″-triacetylchitotriose.

In embodiments of the invention, a detectable label is conjugated to a microbial enzyme substrate. The detectable label can be any moiety that, when cleaved from an enzyme substrate by the activity of the enzyme, forms a detectable moiety (e.g., a light-emitting signal), but that is not detectable in its conjugated state. As used herein, the term “detectable label” refers to a composition detectable by visual, spectroscopic, photochemical, biochemical, immunochemical, or chemical means. Detectable labels include, but are not limited to, fluorescent compounds, isotopic compounds, chromogenic compounds, chelating agents, dyes, quantum dot labels, colloidal gold, latex particles, ligands (e.g., biotin), bioluminescent materials, chemiluminescent agents, enzymes, electron-dense reagents, and haptens or proteins for which antisera or monoclonal antibodies are available. Other detectable labels for use in the invention include, without limitations, magnetic beads or magnetic resonance imaging labels. The various means of detection include, but are not limited to, spectroscopic, photochemical, radiochemical, biochemical, immunochemical, or chemical means.

In some embodiments, the detectable label emits light after it is cleaved from the microbial enzyme substrate, but does not emit light in its conjugated state. In such embodiments, the detectable labels for use in the invention can include a chemiluminescent, a chromogenic or a fluorescent compound. In some embodiments, the detectable label can include fluorescent or chromogenic moieties. Exemplary fluorescent or chromogenic moieties include, without limitation, fluoresceine isothiocyanate, phycoerythrin, Texas red, rhodamine, free or chelated lanthanide series salts, 4-methylumbelliferone or fluorescein. 5-Bromo-4-chloro-3-indolyl, M-nitrophenyl or p-nitrophenyl compounds can also be used. In one embodiment, the detectable label is a fluorescent compound, e.g., 4-methyl-umbelliferone.

The detectable label is conjugated to the microbial enzyme substrate in a manner that cleavage by an enzyme, e.g., present in microbes, results in an unconjugated detectable label, i.e., being released or freed from the substrate-label conjugate. As used herein, the term “conjugated” or “conjugate” refers to two molecules being linked to each other, e.g., attaching a microbial enzyme substrate to a detectable label. The conjugation process can be performed, e.g., via a chemical reaction, or via a linker. In contrast, the term “unconjugated” as used herein refers to a molecule being released from its conjugate, or the molecule present in its original free state. In various embodiments, the detectable label is chemically attached to the microbial enzyme substrate. Techniques for making the conjugates are known to one of ordinary skill in the art, e.g., using the methods described in O'Brien M. et al (1) and Miller M et al (4).

In some embodiments, the targeting molecule is a conjugate of a microbial enzyme substrate and a detectable label. In such embodiments, the targeting molecule is a conjugate of a substrate for chitinase and a detectable label, e.g., 4-methylumbelliferone. In one embodiment, the targeting molecule is 4-methylumbelliferyl-N-acetyl-beta-D-glucosaminide (MUF-NAG). Other targeting molecules that can be used for the purpose of the invention include, but are not limited to, 5-bromo-6-chloro-3-indolyl-2-acetamido-2-deoxy-β-D-gluco-pyranoside, 5-bromo-4-chloro-3-indolyl-N-acetyl-β-D-glucosaminide, indolyl-2-acetamido-2-deoxy-β-D-gluco-pyranoside, 4-nitrophenyl-N-acetyl-β-D-glucosaminide, β-trifluoromethylumbelliferyl-N-acetyl-β-D-glucosaminide, N-methylum-indolyl-N-acetyl-β-D-glucosaminide, 5-iodo-3-indolyl-N-acetyl-β-D-glucosaminide, 4-methylumbelliferyl-β-D-N,N′,N″-triacetylchitotriose, 4-methylumbelliferyl-β-D-N,N′-diacetylchitobioside, 4-methylumbelliferyl-7-(6-sulfo-2-acetamido-2-deoxy)-β-D-glucosaminide, 4-methylumbelliferyl-7-(6-sulfo-2-acetamido-2-deoxy-β-D-glucopyronoside), 4-methylumbelliferyl-N-acetyl-α-D-glucosaminide, 4-methylumbelliferyl-N-acetylgalactosaminide, resorufin-N-acetyl-β-D-glucosaminide, 4-methylumbelliferyl-N-acetyl-α-D-glucosaminide and DDAO (9H-(1,3-dichloro-9,9-dimethylacridin-2-one-7-yl)N-acetyl-β-D-glucosaminide) and all N-actyl-β-D-glucosaminide oligomer derivatives of DDAO.

Enzymatic activity is determined based upon specific cleavage of an enzyme substrate conjugated with a fluorochrome into a readily detectable moiety. The use of substrate molecules comprising fluorescently detectable moieties in conventional assays of enzymatic activities is well established, and can be used in the present invention. See, e.g., (7), (8) and (9). In one embodiment, the detectable moiety is 4-methylumbelliferone or a p-nitrophenyl compound.

The product of the enzyme interaction can be determined by spectrometric measurement, including fluorimetry or colorimetry. For example, the enzyme substrate can comprise a detectable level or a derivative thereof, e.g., a 4-methylumbelliferyl derivative, which on interaction with the enzyme gives rise to 4-methylumbelliferone which is monitored fluorimetrically. Alternatively, the substrate can comprise a nitrophenyl, nitroaniline or similar type of derivative, which on interaction with the enzyme gives rise to a colored product which is monitored colorimetrically.

In various embodiments, the test area can contain at least two, at least three or at least four different targeting molecules (comprising a microbial enzyme substrate conjugated with a detectable label). Each substrate and/or each detectable label can be different from each other in the test area. For example, the same microbial enzyme substrate can be conjugated to two different detectable labels, resulting in two different targeting molecules so that the test results can be cross-validated by comparing the signals at two different wavelengths. Alternatively, different substrates can be conjugated to a distinct detectable label so that each substrate can be differentiated from each other based on the wavelength of light emitted. Accordingly, multiple types of microbes can be simultaneously detected using the test unit of the invention, when different substrates and detectable labels are used for various types of microbes.

The different targeting molecules can be randomly distributed throughout the test area. In some cases, the different targeting molecules can be arranged in a pre-defined configuration within the test area, e.g., by localizing the same targeting molecules to specific regions of the test areas. In some embodiments, the test area can comprise a plurality of test sub-areas, each of which can contain one kind of targeting molecules. The targeting molecules in each sub-area can be the same or different. Depending on the size of the test area, it can be partitioned into any number of test sub-areas according to a user's need or preference, e.g., the test area can comprise at least 2, at least 3, at least 4, at least 5, at least 6, at least 7, at least 8, at least 9, or at least 10 test sub-areas. By way of example, in one embodiment, the test area contains 9 test-subareas, e.g., in a 3×3 array. The test sub-areas in each column or each row contain targeting molecules specific for one type of microbe. In such configuration, 3 different types of microbes can be tested in triplicates on a single test unit of the invention.

In some embodiments, the test unit described herein can contain a plurality of discrete test areas, each of which can contain one kind of targeting molecules. The targeting molecules in each discrete test area can be the same or different. The use of multiple different enzyme substrate-label conjugates allows different types of microorganisms or microbes to be detected simultaneously.

Test areas or sub-areas formed on the base support of the test unit can contain a desired density of targeting molecules (or substrate-label conjugates). In various embodiments, the density of targeting molecules can range from about 0.01 μg per cm² to about 100 μg per cm², from about 0.1 μg per cm² to about 50 μg per cm², from about 0.5 μg per cm² to about 25 μg per cm², or from about 0.5 μg per cm² to about 10 μg per cm². In one embodiment, the amount of targeting molecules is approximately 1.5 μg per cm². The concentration (or density) of the targeting molecules on the test area will depend upon the size of the test area, the size of the test unit, and/or concentration of microbes present in a sample. One of skill in the art can optimize the amount of targeting molecules on the test area according to different embodiments of the test unit described herein or required test conditions.

Various methods known to a skilled artisan can be used to form test areas or subareas on the base support. If an absorbent material such as paper or nitrocellulose is used as the base support, the test areas or test sub-areas can be formed directly onto the base support by infusing a discrete portion of the base support with a desired kind of targeting molecules or enzyme substrate-label conjugate at a pre-determined amount. For example, a desired amount of one or more enzyme substrate-label conjugates (targeting molecules) can be suspended in a solution, e.g., water or a buffer, and the suspension can then be applied to one or more designated areas of the base support. In other embodiments, each different enzyme substrate-label conjugate can be prepared in a separate suspension, which can then be applied to respective designated areas of the base support. The advantage of having different discrete test areas or test sub-areas for each enzyme substrate-label conjugate, rather than a single test area containing a mixture of several different conjugates, is that the same detectable label can be used with different enzyme substrates, and the results can be differentiated from each other based on location on the base support. Information relating to the identity of each enzyme-label conjugate and corresponding locations on the test unit can be encoded in the identification area of the test unit, which will be discussed later.

In various embodiments, suspensions of targeting molecules can be applied onto the base support to form test areas or subareas, either manually or by a robotic process, e.g., using a programmed machine such as a printer. In one embodiment, the prepared suspensions can be spotted on the base support by hand, as described in the Example. In another embodiment, the prepared suspensions can be loaded into one or more cartridges of a printer, and then spotted or printed on the designated areas of the base support. Each test area or sub-areas can be of any size, e.g., in a micrometer to centimeter range, depending upon a variety of factors. Such factors can include, for example, a user's preference, desired detection sensitivity or accuracy, surface dimensions of the base support, desired number of test areas or subareas, and/or methods selected to form test areas on the test unit. In various embodiments, the suspension applied onto the discrete areas of the base support can let dried afterward before use.

If the base member is a non-absorbent material, such as glass or plastic, the test areas or subareas can be formed by affixing to the base support an absorbent material, which has been infused or will be infused thereafter, with a suspension of enzyme substrate-label conjugates, e.g., using similar techniques as described above. The types of absorbent material that can be used for the purpose of the invention can be any absorbent paper, porous membranes, porous absorbent cellulosic paper or cellulose filter paper such as those available from Whatman Ltd.

Alternatively, the enzyme substrate-label conjugate can be dispersed in a coating material, which can be then applied onto the base support to form the test area. Using these techniques, a single test area can be formed containing two or more enzyme substrate-label conjugates, i.e., by infusing the absorbent material with a mixture of conjugates, or dispersing the mixture into the coating material. These techniques can also be used to form a plurality of discrete test areas or subareas, each containing a different enzyme substrate-label conjugate, by infusing several pieces of absorbent paper each with a different enzyme substrate-label conjugate, and affixing each to the bases support; or by dispersing the several different enzyme substrate-label conjugates into separate coating materials, and applying the coatings to the base support such that several discrete test areas or subareas can be formed. Exemplary coating materials include, but are not limited to, gelatin, polygalacturonic acid, pectin, agar, agarose, cellulose, carboxymethyl cellulose, plant gums (e.g., guar, xanthan, acacia), starch, polyvinyl alcohol, polyvinyl chloride and polyacrylamide. The coating can be formed on the base support using well-established coating techniques, e.g., film coating or droplet coating. In some embodiments, the coating formed can be dry and stable. In some embodiments, the coating formed can remain stable when wetted. In such embodiments, the coating can be sticky when wetted. In various embodiments, the coating can have a coating weight of less than 10 mg per square inch, less than 5 mg per square inch, less than 2.5 mg per square inch, or less than 1 mg per square inch. In one embodiment, the coating weight is no more than 1 mg per square inch.

### Control Area of the Test Unit

In embodiments of the invention, the test unit also includes at least one control area containing at least one known amount of the detectable label in an unconjugated state. The detectable label used in the control area should correspond to the one used in the test areas, but in its free state, e.g., unconjugated to a microbial enzyme substrate. If more than one enzyme substrate-label conjugates are used in the test area(s) or subareas, the control area should include known amounts of each of the detectable labels used in the test area(s) or subareas. In one aspect, the control area can act as a negative control by detecting background emissions present in the sample. For example, some samples can contain some constituents that autofluorescence, e.g., latex, and thus interfere with signal detection. In another aspect, the control area can be used to provide calibration standards, for example, providing one or more known quantities of the detectable labels that can be used as a basis for comparison with the quantity of signal emitted from the test area.

In some embodiments, the test unit described herein can contain a plurality of discrete control areas, each of which can contain at least one known amount of the detectable label in its unconjugated state. The unconjugated detectable label in each discrete control area can be the same or different. The known amount of the unconjugated detectable label in each discrete control area can be the same or different.

In some embodiments, any control area can comprise a plurality of subareas containing a known amount of the detectable label in its unconjugated state. In some embodiments, the control area can comprise at least two or more subareas. In some embodiments, the control area can comprise at least three, at least four, at least five, at least six, at least seven, at least eight, at least nine, at least ten subareas. The known amount of the unconjugated detectable label in each subarea can be the same or vary. In one embodiment, the amounts of the unconjugated detectable label in at least some subareas are different and/or within a defined range of concentrations, thereby providing an integral calibration standard. The defined range of concentrations can vary upon different embodiments of the test units and types of samples to be tested. If the test unit is configured to detect minute level of microbes, the defined range of the unconjugated detectable label amount can vary from about 0.001 μg to about 1000 μg, from about 0.01 μg to about 500 μg, from about 1 μg to about 250 μg, or from about 1 μg to about 100 μg. In some embodiments, the defined range of the unconjugated detectable label amount can be beyond 1 mg, 2 mg, 5 mg or 10 mg. In some embodiments, the lower limit of the unconjugated detectable label amount can be defined by the minimum amount of the detectable label required to yield a detectable signal. The upper limit thereof can be defined by the maximum amount of the detectable label allowed before reaching a saturated signal. An ordinary skill in the art can readily determine the known amount(s) of the detectable label(s) to be used in the control area(s) based upon various applications, expected range of signal level emitted from the test area and/or expected concentration range of microbes present in a sample.

The control area(s) can be formed on the base support using the same materials and/or techniques as described above for the test areas. In some embodiments, the same materials and/or techniques should be used to form test areas and control areas on the base support, in order to minimize the differences between the test and control areas.

In some embodiments of the invention, the base support of the test unit can further comprise an identification element disposed thereon. The identification element can contain some stored data, e.g., information about the test unit. Such test unit information can include a batch number, types and concentrations of enzyme substrate-label conjugates in the test areas with corresponding locations on the test unit, and/or types and concentrations of the unconjugated detectable labels in the control areas with corresponding locations on the test unit. In some embodiments, the identification element can be used to store new data, such as sample information, and detection condition. For example, sample types, location of samples taken, sample number, calibration standards, temperature, relative humidity, pH, algorithms, and any other information that can be used to analyze the signal obtained from the test unit or identify the test or microbes. Examples of identification elements include, but are not limited to, a bar code, radio frequency (RF) micro device, a RF identification label, a microchip or a machine-readable tag, e.g., a computer-readable tag. Other forms of machine-readable information can also be employed in the present invention, such as magnetic ink character recognition (MICR) and optical character recognition (OCR). Other types of machine-readable information and their adaptation to the present invention will be obvious to one of skill in the art. In some embodiments, the identification element can be a blank writable area for a user to fill in sample information.

### Methods of the Invention

The test units of the invention are used for determination of microbes in various samples. Accordingly, another aspect of the invention provides methods for determining presence or absence of microbes in a sample or on a sample surface. The method includes (a) contacting a sample to be detected with at least one test area and at least one control area of a test unit described herein, and (b) detecting a signal emitted from the unconjugated detectable labels in the test and control areas of the test unit of step (a), wherein the detectable label of the targeting molecules is released from the microbial enzyme substrate and becomes unconjugated in the presence of microbes.

As used herein, the term “contacting” refers to any suitable means for transferring any substance present on a sample surface or in a sample to the test and control areas of the test unit described herein. The contact with the test areas and control areas of the test unit can be simultaneous, or in a sequential manner, e.g., contacting test areas followed by control areas, or vice versa. Modes of contact include, but are not limited to, rubbing, swabbing, wiping, touching and immersing (into a fluid). In one embodiment, the test unit can be brought into contact with a sample surface by a gentle rubbing. In another embodiment, the test unit can be immersed into a sample fluid, e.g., a solution or gas. In some embodiments, the contact is performed on a sample surface, e.g., a solid or a gel surface. In some embodiments, the contact is performed in a sample, e.g., in a fluid such as liquid or air. In some embodiments, the contact is in situ. By “in situ contact” meant the test unit being in contact with the sample in its natural state or habitat. For example, if the ceiling boards of a building need to be tested for microbes, the test unit can be directly brought into contact with the ceiling boards of the building, instead of scrapping a sample off the ceiling boards of the building followed by a transfer of the sample onto the test unit.

While a sample can be in contact with at least one test area and/or at least one control area for any period of time, e.g., minutes, hours or days, the contact duration of the sample with both the test areas and control areas should be about the same. The contact can be maintained for an amount of time sufficient to ensure that any microbes or microorganisms present on a sample surface or in a sample are transferred to or collected by the test unit. For example, when the sample is a solid surface or a liquid, the test unit can contact the sample for about 1 second to about 100 seconds, for about 1 second to about 50 seconds, or for about 1 second to about 25 seconds. When a gas sample, e.g., air, is being tested, the test unit can be in contact with the gas sample for several hours, or the test unit can be in continuous contact with the sample. In some embodiments, the test unit can be removed from a sample immediately after it contacts the sample. A skilled artisan can adjust the contact time accordingly, e.g., depending on concentrations and types of microbes present in a sample.

In certain embodiments, an incubation period after sample contact can be required or desirable prior to signal detection, in order to provide sufficient time for the enzymes in the microbes present in the sample to react with the microbial enzyme substrates on the test unit. One of skill in the art can readily adjust the length of the incubation period, based upon the detection labels being used and the type of microorganism being detected. In certain embodiments, the incubation period can be from about 1 second to about 1 hour, from about 10 seconds to about 50 minutes, from about 30 seconds to about 40 minutes, or from about 1 minute to about 30 minutes, or from about 5 minutes to about 30 minutes, or from about 10 minutes to about 15 minutes. The incubation can be carried out at an ambient temperature or above. In one embodiment, the incubation is carried out at about 30° C. In some embodiments, the incubation can be carried out in a temperature-controlled environment. In some embodiments, the incubation can be carried out in the dark.

After contacting the test unit with the sample and optional incubation, without wishing to be bound by theory, enzymes in the microbes can cleave enzyme substrate conjugated with a detectable label into unconjugated detectable label, which readily produce a positive signal. Accordingly, after contact with the sample, the signal emitted from the unconjugated detectable labels in the test areas and control areas of the test unit are detected. The signal can be detected and measured over a period of time, e.g., minutes or hours. If the concentration of microbes present in sample is low, the signal can be measured over a longer period of time. In some embodiments, the signal can be measured continuously for several hours.

The signal can be any detectable signal, e.g., a magnetic signal, or an optical signal such as a fluorescent signal, a chromogenic signal or a chemiluminescent signal. In some embodiments, the signal can be light with a wavelength selected from an infra-red, visible or ultraviolet range. In some embodiments, the signal is fluorescent, e.g., fluorescent light emitted by 4-methyl-umbelliferone or its derivative thereof. In such embodiments, the signal can be detected with a light-detecting device. Exemplary light-detecting device include, without limitations, a spectrometer, a fluorometer, a colorimeter or any instrument that can detect light in an infra-red, visible and/or ultraviolet range.

In some embodiments, the methods of the invention further comprise a step of determining the amount of microbes by comparing the signal of the test area with the signal of the control area. Such comparison step can involve computational analysis, e.g., using a data processor and/or analyzer. For example, the fluorescence signals measured from a known range of the detectable label concentrations in the control area(s) can generate a calibration curve. Measuring the amount of light emission from the test area and comparing the value against the calibration curve can quantitatively determine the amount of microbes present in a sample or on its surface.

In one specific embodiment, the method comprises contacting a test strip as described herein with a surface suspected of harboring microbial contamination. In one embodiment, the test strips are used to collect material from a surface, such as a building material or cultural heritage object. The test strip can be provided in a pre-moistened condition. The test strip is brought into direct contact with the surface for a time sufficient to collect samples of microorganisms residing on the surface, typically from about 1 to about 10 seconds, then is removed, and, if necessary, briefly incubated to allow time for enzymes present in the microorganisms to react with the enzyme substrate in the test strip, and cleave the detectable label from the substrate. The incubation step is carried out for a time and under conditions sufficient to permit the enzyme in the sample to react with the substrate conjugate and liberate the detectable moiety. The time required typically is between about 1 to about 30 minutes, preferably between about 10 and 15 minutes.

The test strip is then assayed by detecting and measuring the light emitted from the test and control areas. The signal generated on the test strip by light emitted from the free detectable label can be detected and measured using a photoelectric cell, for example. The data are processed and the signal is assigned with a numeric intensity based on pre-established standards, some of which may be included in the control area, thereby quantifying the amount of detectable label. The amount of free detectable label observed in the test area correlates directly with the quantity of the microorganism on the surface.

In one embodiment, the method of the invention comprises determining the presence and/or amount of fungal spores on a sample surface by detecting the activity of fungal chitinase using a fluorescently-labeled chitinase substrate. In this embodiment, a sample suspected of harboring fungal spores is contacted with a test unit described herein, e.g., a test strip (comprising a test area containing a chitinase substrate conjugated with a fluorescent moiety, and a control area containing a known quantity of the fluorescent moiety). Exemplary conjugates include, without limitations, 4-methylumbelliferyl-N-acetyl-β-D-glucosaminide, 4-methylumbelliferyl-N-acetyl-β-D-glucosamine, 4-methylumbelliferyl-N,N′-diacetyl-β-D-chitobioside and 4-methylumbelliferyl-β-D-N,N′,N″-triacetylchitotriose. The test unit, e.g., a test strip, is then submitted to the detector/data processor, where the amount of fluorescence emitted from both the test and control areas is determined and analyzed, and a read-out is provided showing the amount of fungal spores present on the sample.

Conventional methods for microbe detection usually involve at least one step prior to, or after contacting the sample with a microbial enzyme substrate. For example, conventional methods involve culturing microbes collected from a sample, suspending an isolated microbial colony (from the culture) in a solution, and/or addition of a reagent, e.g., a substrate-label conjugate solution or a reaction stopping solution, to the suspended culture. In accordance with the invention, the methods do not require any user preparation prior to placing the test units in contact with a sample. Any user can simply place the test unit of the invention in contact with a surface to be tested, then insert the test unit into the detector/processor for analysis, without the use of any additional reagents or special handling. Moreover, the sample or its surface also does not require any special preparation, e.g., it does not require that the microorganisms present on the sample surface be collected, grown or cultured, lysed or activated prior to identification. In some embodiments, the methods of the invention require no suspension of the sample in a fluid prior to the contacting step. In additional embodiments, the methods of the invention require no culturing of microbes collected from the sample prior to the contacting step.

In additional embodiments, the methods described herein can be entirely non-fluidic, that is, the method does not require the addition of any reagents to the test unit before or after it is contacted with the sample. Most prior art strip-based detection systems require that the sample be suspended in a liquid, then applied to the surface of the test strip; or require that a liquid reagent to be applied to the test strip, for example, to induce color formation. The methods of the invention do not require a sample to be suspended in a liquid, and do not require the use of any liquid reagents. However, it should be appreciated that any of these conventional steps can still be used with the methods described herein if desired.

### Systems and Kits of the Invention

A further aspect of the invention provides systems for determining presence or an amount of microbes in a sample or on its surface thereof. The system can include (a) a sample module configured to receive at least one test unit described herein; (b) a light-detecting device configured to detect light emitted from the test and control areas; (c) a computing module adapted to compare the light emission data of the test area with that of the control area; and (d) a display module for displaying an output from the computing module, wherein the output includes an indicator of whether any microbe was identified, the detected microbe, and/or the amount of the detected microbe.

The sample module, e.g., a sample holder, can be configured to receive at least one, at least two, at least three, at least four, at least five, at least six, at least seven, at least eight, at least nine or at least ten test units described herein. Multiple sample slots can allow high-throughput detection and analysis of the test units described herein.

The test units placed in the sample module are then subjected to a light-detecting device. The light-detecting device is configured to detect light emitted from the test and control areas. Light-detecting instruments for measuring fluorescence or other emissions are well-known in the art. For example, spectrometers for detecting fluorescence and other emissions can be available from PerkinElmer and Thermo Scientific. In one embodiment, the system of the invention utilizes a light-detecting device, which comprises a light emitter and a light sensor, e.g., integrated into a single unit. In one embodiment, the light emitter is capable of emitting light in an infrared, visible or ultraviolet range. In some embodiments, the light-detecting device can comprise a photoelectric cell. As used herein, the term “a photoelectric cell” is an electronic device that produces an electrical output in response to incident radiation, e.g., to visible light. The system further comprises a data processor capable of analyzing the emissions data and providing a read-out or result. In one embodiment, the light-detecting device and the data processor are integrated for this purpose.

The “computing module” can use a variety of available software programs and formats for generating calibration standards and/or accounting for background emission, based on the signals detected from the control area. In addition, the computing module can further comprise a comparison module, which compares the light emission data of the test area with that of the control area. In one embodiment, the signal detected from the test area can be compared against the calibration standards resulted from the control area signals to quantitatively determine the amount of microbes in a sample or on its surface. In another embodiment, the signal detected from the test area can be compared or matched with an individual signal detected from the control area. During the comparison or matching process, the comparison module can determine whether the amount of microbes in a sample is above or below a known concentration, e.g., a threshold level. In some circumstances, if the test area signal is below the lowest known concentrations of detectable labels in the control area(s), the comparison module can generate an output indicating the level of microbes below detection limit. In various embodiments, the comparison module can be configured using existing commercially-available or freely-available software for comparison purpose, and may be optimized for particular data comparisons that are conducted.

The computing and/or comparison module, or any other module of the invention, can include an operating system (e.g., UNIX) on which runs a relational database management system, a World Wide Web application, and a World Wide Web server. World Wide Web application includes the executable code necessary for generation of database language statements (e.g., Structured Query Language (SQL) statements). Generally, the executables will include embedded SQL statements. In addition, the World Wide Web application may include a configuration file which contains pointers and addresses to the various software entities that comprise the server as well as the various external and internal databases which must be accessed to service user requests. The Configuration file also directs requests for server resources to the appropriate hardware—as may be necessary should the server be distributed over two or more separate computers. In one embodiment, the World Wide Web server supports a TCP/IP protocol. Local networks such as this are sometimes referred to as “Intranets.” An advantage of such Intranets is that they allow easy communication with public domain databases residing on the World Wide Web (e.g., the GenBank or Swiss Pro World Wide Web site). Thus, in one embodiment, users can directly access data (via Hypertext links for example) residing on Internet databases using a HTML interface provided by Web browsers and Web servers.

The computing and/or comparison module provides a computer readable comparison result that can be processed in computer readable form by predefined criteria, or criteria defined by a user, to provide a content-based in part on the comparison result that can be stored and output as requested by a user using an output module, e.g., a display module.

In some embodiments, the content displayed on the display module can include an indicator of whether any microbe was identified. In some embodiments, the content displayed on the display module can include a numerical value indicating the amount of microbes present in a sample. In some embodiments, the content displayed on the display module can be a single word or phrases to qualitatively indicate the likelihood of a sample be contaminated with microbes. For example, a word “unlikely” can be used to indicate a lower risk for a sample to have microbial contamination, while “likely” can be used to indicate a high risk for microbial contamination. In some embodiments, the content displayed on the display module can be a word or an index indicating the types or species of detected microbes.

In one embodiment of the invention, the content based on the computing and/or comparison result is displayed on a computer monitor. In one embodiment of the invention, the content based on the computing and/or comparison result is displayed through printable media. The display module can be any suitable device configured to receive from a computer and display computer readable information to a user. Non-limiting examples include, for example, general-purpose computers such as those based on Intel PENTIUM-type processor, Motorola PowerPC, Sun UltraSPARC, Hewlett-Packard PA-RISC processors, any of a variety of processors available from Advanced Micro Devices (AMD) of Sunnyvale, Calif., or any other type of processor, visual display devices such as flat panel displays, cathode ray tubes and the like, as well as computer printers of various types.

In one embodiment, a World Wide Web browser is used for providing a user interface for display of the content based on the computing/comparison result. It should be understood that other modules of the invention can be adapted to have a web browser interface. Through the Web browser, a user can construct requests for retrieving data from the computing/comparison module. Thus, the user will typically point and click to user interface elements such as buttons, pull down menus, scroll bars and the like conventionally employed in graphical user interfaces.

Systems and computer readable media described herein are merely illustrative embodiments of the invention for detection of microbes in a sample or on its surface, and therefore are not intended to limit the scope of the invention. Variations of the systems and computer readable media described herein are possible and are intended to fall within the scope of the invention.

The system of the invention can also include sensors for determining ambient conditions, such as temperature and/or relative humidity. In some embodiments, the sensors and/or detectors can also be integrated with the data processor such that the results obtained from the test unit can be adjusted for temperature or humidity. The system can also include a detector for reading information on the identification strip. The data processor can also be capable of utilizing and analyzing applicable information, such as calibration data, incorporated into the identification area.

The system can further comprise a module for transmitting data to a receiver, such as a computer. The transmitting module can comprise wireless transmission, e.g., via a cellular network or wireless interne, or can be a direct connection e.g., via a usb connection to the receiving computer.

The modules of the machine, or those used in the computer readable medium, may assume numerous configurations. For example, function may be provided on a single machine or distributed over multiple machines. One embodiment of the invention provides an integrated system for determining the presence and amount of microorganisms present on a test sample. The system utilizes a test unit of the invention, detection means, and a data processor. In one embodiment, the system utilizes a test strip containing on its surface a test area comprising one or more enzyme substrates specific for the types of microbes being detected conjugated with a detectable label, e.g., a light-emitting compound that does not emit light when conjugated with the enzyme substrate but does emit light in its unconjugated state. The accuracy of the system is improved by the presence of a control area that contains known amounts of the same light-emitting compound used in the test area in its free state. The control area detects any background emissions that could skew the emissions data from the test area, and also can provide emission data from known quantities of the light-emitting compound that can serve as calibration standards.

Assays and kits for detection of presence and/or degree of microbial contamination are also provided herein. The assay comprises a test strip as described herein, and means for detecting the output from the unconjugated detectable label on the test strip, e.g., a spectrometer or other instrument. The assay may further comprise a calibration chart, reagents (buffers, etc.) and/or implements or receptacles for sample collection, preparation or evaluation. The assays may be formulated into kits that include all or some of the materials needed to conduct the analysis, including reagents, implements, instruments and/or instructions.

The assays and methods provided herein can be carried out at a test site. Kits can be designed that allow the assay to be easily performed at a desired location. Accordingly, kits for detecting the presence and/or amount of microbial contamination are also provided herein. In certain embodiments, the kits can include at least one tests strip described above for performing the assay, as well as an instrument for detection of the detectable label and analysis of the results, e.g., a portable detector and data processor. For example, small, lightweight, portable UV and fluorescence spectrometers are available from Thermo Scientific. The kit optionally may contain additional reagents, implements and/or instructions for carrying out the assay.

In some embodiments, the kit can include a plurality of the test units described herein and an instruction manual. In such embodiments, the kit can include at least 2, at least 3, at least 4, at least 5, at least 6, at least 7, at least 8, at least 9, at least 10, at least 20, at least 30, at least 40, at least 50, or at least 100 test units. In some embodiments, the plurality of the test units are discrete test units. In such embodiments, the test units can be individually packaged in a pre-moistened state in a moisture-tight container. The user can simply remove a strip from the container, place it in contact with a surface to be tested, then insert the strip into the detector/processor for analysis, without the use of any additional reagents or special handling. In alternative embodiments, the plurality of the test units are embodied in a continuous roll. In such embodiments, the test and control areas can be in the form of continuous lines or a series of spots. In some embodiments, the kits of the invention further comprise a portable light-detecting device, e.g., a hand-held spectrometer, fluorimeter or a colorimeter.

### Microbes and Samples to be Tested

Methods, test units, systems and kits of the invention are applicable to determination of microbes in various samples and/or environments. As used herein, the term “microbes” refers to microorganisms, including bacteria, fungi, protozoan, archaea, protists, e.g., algae, and a combination thereof. The term “microbes” also includes pathogenic microbes, e.g., bacteria causing diseases such as plague, tuberculosis and anthrax; protozoa causing diseases such as malaria, sleeping sickness and toxoplasmosis; and fungi causing diseases such as ringworm, candidiasis or histoplasmosis.

In some embodiments, the microbes are fungi, e.g., yeast, molds. Exemplary fungi and yeast include, but are not limited to, Cryptococcus neoformans, Candida albicans, Candida tropicalis, Candida stellatoidea, Candida glabrata, Candida krusei, Candida parapsilosis, Candida guilliermondii, Candida viswanathii, Candida lusitaniae, Rhodotorula mucilaginosa, Aspergillus fumigatus, Aspergillus flavus, Aspergillus clavatus, Cryptococcus neoformans, Cryptococcus laurentii, Cryptococcus albidus, Cryptococcus gattii, Histoplasma capsulatum, Pneumocystis jirovecii (or Pneumocystis carinii), Stachybotrys chartarum, and any combination thereof.

Non-limiting examples of molds include Acremonium, Aspergillus, Alternaria, Chaetomium, Cladosporium, Fusarium, Mucor, Penicillium, Rhizopus, Stachybotrys, Trichoderma. In one embodiment, the microbe is Stachybotrys. Species of Stachybotrys includes, but are not limited to, Stachybotrys alternans, Stachybotrys breviuscula, Stachybotrys chartarum, Stachybotrys cylindrospora, Stachybotrys dichroa, Stachybotrys elegans, Stachybotrys eucylindrospora, Stachybotrys freycinetiae, Stachybotrys kampalensis, Stachybotrys kapiti, Stachybotrys longispora, Stachybotrys mangiferae, Stachybotrys microspora, Stachybotrys nephrodes, Stachybotrys nephrospora, Stachybotrys nilagirica, Stachybotrys oenanthes, Stachybotrys parvispora, Stachybotrys ruwenzoriensis, Stachybotrys sansevieriae, Stachybotrys sinuatophora, Stachybotrys suthepensis Photita, Stachybotrys theobromae and Stachybotrys waitakere.

The most well-known species, S. chartarum (also known as S. atra) is known as “black mold” or “toxic black mold,” and is frequently associated with poor indoor air quality that arises after fungal growth on water-damaged building materials.

In some embodiments, the microbes are bacteria. Exemplary bacteria include, but are not limited to: anthrax, campylobacter, cholera, diphtheria, enterotoxigenic E. coli, giardia, gonococcus, Helicobacter pylori, Hemophilus influenza B, Hemophilus influenza non-typable, meningococcus, pertussis, pneumococcus, salmonella, shigella, Streptococcus B, group A Streptococcus, tetanus, Vibrio cholerae, yersinia, Staphylococcus, Pseudomonas species, Clostridia species, Myocobacterium tuberculosis, Mycobacterium leprae, Listeria monocytogenes, Salmonella typhi, Shigella dysenteriae, Yersinia pestis, Brucella species, Legionella pneumophila, Rickettsiae, Chlamydia, Clostridium perfringens, Clostridium botulinum, Staphylococcus aureus, Treponema pallidum, Haemophilus influenzae, Treponema pallidum, Klebsiella pneumoniae, Pseudomonas aeruginosa, Cryptosporidium parvum, Streptococcus pneumoniae, Bordetella pertussis, Neisseria meningitides, and any combination thereof.

Microbial infection or contamination can be present anywhere. While some microbial species can be used in fermentation of foods or for production of desired gene products, e.g., enzymes and antibiotics, microbes can also cause spoilage of various materials, e.g., food and agricultural products, rotting in building materials, and can be pathogenic to mammals including humans. As such, aspects of the invention can be used in various types of samples or environmental surfaces. For example, the sample can be an environmental sample collected from soil, water or air. In some embodiments, the sample can be a surface in buildings, e.g., building material, ceiling boards or walls, or surface of medical devices, e.g., in clinics or hospitals. In some embodiments, the sample can be an agricultural and/or food product and/or its surface thereof. Such agricultural and/or food products can include, but are not limited to, fermented products for human or animal consumption, field crops, plants, vegetables, fruits, grains, seeds, and nuts. Harvested products can also be assayed, e.g., during storage, to evaluate the level of microbial contamination. Other food product, e.g., a heat processed food product, a food component, a feed product and a feed component are also amenable to the methods and systems of the invention. In some embodiments, the sample can be a cultural heritage material, e.g., paintings and historic paper documents, monuments, statues, or building facades. Paper and canvas, the cellulosic substrata of paintings and historic documents, can be stained and degraded by fungi. Early detection of microbial growth can permit the use of relatively non-invasive treatments to remediate cultural artifacts before visible or lasting damage has occurred.

In some embodiments, the sample can be a biological sample, e.g., a sample collected from a biological organism. Examples of biological samples include, but are not limited to, blood, sputum, urine, spinal fluid, pleural fluid, nipple aspirates, lymph fluid, the external sections of the skin, respiratory, intestinal, and genitourinary tracts, tears, saliva, milk, feces, sperm, leukocyte fractions, smears, tissue samples of all kinds, plants and parts of plants.

In some embodiments, biological samples can be collected from a subject. As used herein, a “subject” means a human or animal. Usually the animal is a vertebrate such as a primate, rodent, domestic animal, domestic pet or game animal. Primates include chimpanzees, cynomologous monkeys, spider monkeys, and macaques, e.g., Rhesus. Rodents include mice, rats, woodchucks, ferrets, rabbits and hamsters. Domestic and game animals include cows, horses, pigs, deer, bison, buffalo, feline species, e.g., domestic cat, canine species, e.g., dog, fox, wolf, avian species, e.g., chicken, emu, ostrich, and fish, e.g., trout, catfish and salmon. In some embodiments, the subject is a mammal. The mammal can be a human, non-human primate, mouse, rat, dog, cat, horse, or cow, but are not limited to these examples.

Microbial contamination, especially fungal contamination, in an environment (air, food, soil) or on the surface of or within objects (medical devices, air ducts, surfaces in hospitals) poses serious health concerns. In addition, the presence of fungi on archival books or documents can cause the deterioration of important historical information and objects. Methods and assays capable of quickly and accurately determining the presence and amount of microbial contamination are critical for identifying such contamination before a serious problem develops. The present invention provides an effective and robust method for rapidly and accurately determining the presence and extent of numerous types of microbial contamination. Moreover, in contrast to prior methods that require specialized laboratory facilities for culturing and growing cells, the present methods and assays can be performed at the location using portable inexpensive equipment that can be operated with a minimum of training.

### Some Selected Definitions

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments of the aspects described herein, and are not intended to limit the paragraphed invention, because the scope of the invention is limited only by the paragraphs. Further, unless otherwise required by context, singular terms shall include pluralities and plural terms shall include the singular.

As used herein the term “comprising” or “comprises” is used in reference to compositions, methods, and respective component(s) thereof, that are essential to the invention, yet open to the inclusion of unspecified elements, whether essential or not.

The term “consisting of” refers to compositions, methods, and respective components thereof as described herein, which are exclusive of any element not recited in that description of the embodiment.

Other than in the operating examples, or where otherwise indicated, all numbers expressing quantities of ingredients or reaction conditions used herein should be understood as modified in all instances by the term “about.” The term “about” when used in connection with percentages may mean ±1%.

The singular terms “a,” “an,” and “the” include plural referents unless context clearly indicates otherwise. Similarly, the word “or” is intended to include “and” unless the context clearly indicates otherwise. Thus for example, references to “the method” includes one or more methods, and/or steps of the type described herein and/or which will become apparent to those persons skilled in the art upon reading this disclosure and so forth.

Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

In one respect, the present invention relates to the herein described compositions, methods, and respective component(s) thereof, as essential to the invention, yet open to the inclusion of unspecified elements, essential or not (“comprising). In some embodiments, other elements to be included in the description of the composition, method or respective component thereof are limited to those that do not materially affect the basic and novel characteristic(s) of the invention (“consisting essentially of”). This applies equally to steps within a described method as well as compositions and components therein. In other embodiments, the inventions, compositions, methods, and respective components thereof, described herein are intended to be exclusive of any element not deemed an essential element to the component, composition or method (“consisting of”). The present invention is not limited to the particular methodology, protocols, and reagents, etc., described herein and as such may vary. The terminology used herein is for the purpose of describing particular embodiments only, and is not intended to limit the scope of the present invention, which is defined solely by the claims.

The present invention may be defined in any of the following numbered paragraphs:
1. A method for detecting presence or absence of microbes, comprising the steps of:
(a) contacting a sample to be detected with a test unit comprising a base support having disposed thereon (i) at least one test area containing one or more targeting molecules comprising a microbial enzyme substrate conjugated with a detectable label, and (ii) at least one control area containing at least one known amount of the detectable label in an unconjugated state, and
(b) detecting a signal emitted from the unconjugated detectable labels in the test and control areas of the test unit of step (a), wherein the detectable label of the targeting molecules is released from the microbial enzyme substrate and becomes unconjugated in the presence of microbes.
2. The method of paragraph 1, wherein the contacting is on a solid surface.
3. The method of paragraph 1, wherein the contacting is in liquid.
4. The method of paragraph 1, wherein the contacting is in air.
5. The method of any of paragraphs 1-4, wherein the contacting is in situ.
6. The method of any of paragraphs 1-5, wherein the method requires no suspension of the sample in a fluid prior to step (a).
7. The method of any of paragraphs 1-6, wherein the method requires no addition of a reagent to the test unit prior to or after step (a).
8. The method of any of paragraphs 1-7, wherein the method requires no culturing of microbes collected from the sample prior to step (a).
9. The method of any of paragraphs 1-8, wherein the signal to be detected in step (b) is light with a wavelength selected from an infra-red, visible or ultraviolet range.
10. The method of paragraph 9, wherein the detecting is performed with a light-detecting device.
11. The method of paragraph 10, wherein the light-detecting device is a spectrometer.
12. The method of any of paragraphs 1-11, further comprising incubating the test unit after step (a) to allow enzymes in the microbes to react with the microbial enzyme substrate on the test unit.
13. The method of any of paragraphs 1-12, further comprising a step of determining the amount of microbes by comparing the signal of the test area with the signal of the control area.
14. The method of any of paragraphs 1-13, wherein the microbial enzyme substrate is N-acetyl-β-D-glucosaminide, N-acetyl-β-D-glucosamine, N,N′-diacetyl-β-D-chitobioside or β-D-N,N′,N″-triacetylchitotriose.
15. The method of any of paragraphs 1-14, wherein the detectable label is a chemiluminescent, chromogenic or fluorescent compound.
16. The method of paragraph 15, wherein the fluorescent compound is 4-methyl-umbelliferone.
17. The method of any of paragraphs 1-16, wherein the at least one test area comprises at least two different targeting molecules comprising a microbial enzyme substrate conjugated with a detectable label.
18. The method of any of paragraphs 1-17, wherein the at least one test area comprises a plurality of test sub-areas containing a targeting molecule, the targeting molecule comprising a microbial enzyme substrate conjugated with a detectable label.
19. The method of paragraph 18, wherein the targeting molecule is the same in each test sub-area.
20. The method of paragraph 18, wherein the targeting molecule is different in each test sub-area.
21. The method of any of paragraphs 1-20, wherein the at least one control area comprises a plurality of sub-areas containing a known amount of the detectable label.
22. The method of paragraph 21, wherein the known amount of the detectable label in each sub-area is the same.
23. The method of paragraph 21, wherein the known amount of the detectable label in each sub-area is different.
24. The method of any of paragraphs 1-23, further comprising an identification element disposed thereon.
25. The method of paragraph 24, wherein the identification element stores data selected from the group consisting of sample information, test unit information, and detection condition.
26. The method of paragraph 24 or 25, wherein the identification element is selected from a bar code, a radio frequency identification label, a microchip or a computer-readable tag.
27. The method of any of paragraphs 1-26, wherein the microbes are selected from fungi, bacteria or a combination thereof.
28. A test unit for detecting presence or absence of microbes comprising:
   a base support having disposed thereon (a) at least one test area containing one or more targeting molecules comprising a microbial enzyme substrate conjugated with a detectable label, and (b) at least one control area containing at least one known amount of the detectable label in an unconjugated state.
29. The test unit of paragraph 28, wherein the microbial enzyme substrate is N-acetyl-β-D-glucosaminide, N-acetyl-β-D-glucosamine, N,N′-diacetyl-β-D-chitobioside or β-D-N,N′,N″-triacetylchitotriose.
30. The test unit of paragraph 28, wherein the detectable label emits light when it is in the unconjugated state.
31. The test unit of paragraph 30, wherein the detectable label is a chemiluminescent, chromogenic or fluorescent compound.
32. The test unit of paragraph 31, wherein the fluorescent compound is 4-methyl-umbelliferone.
33. The test unit of any of paragraphs 28-32, wherein the at least one test area comprises at least two different targeting molecules comprising a microbial enzyme substrate conjugated with a detectable label.
34. The test unit of any of paragraphs 28-33, wherein the at least one test area comprises a plurality of test sub-areas containing a targeting molecule, the targeting molecule comprising a microbial enzyme substrate conjugated with a detectable label.
35. The test unit of paragraph 34, wherein the targeting molecule is the same in each test sub-area.
36. The test unit of paragraph 34, wherein the targeting molecule is different in each test sub-area.
37. The test unit of any of paragraphs 28-36, wherein the at least one control area comprises a plurality of sub-areas containing a known amount of the detectable label.
38. The test unit of paragraph 37, wherein the known amount of the detectable label in each sub-area is the same.
39. The test unit of paragraph 37, wherein the known amount of the detectable label in each sub-area is different.
40. The test unit of any of paragraphs 28-39, further comprising an identification element disposed thereon.
41. The test unit of paragraph 40, wherein the identification element stores data selected from the group consisting of: sample information, test unit information, and detection condition.
42. The test unit of paragraph 41, wherein the identification element is selected from a bar code, a radio frequency identification label, a microchip or a computer-readable tag.
43. A system for determining presence or an amount of microbes in a sample comprising:
   (a) a sample module configured to receive at least one test unit of any of paragraphs 28 to 42;
   (b) a light-detecting device configured to detect light emitted from the test and control areas;
   (c) a computing module adapted to compare the light emission data of the test area stored on the storage module with that of the control area.
   (d) a display module for displaying an output from the computing module, wherein the output includes an indicator of whether any microbe was identified, the detected microbe, and/or the amount of the detected microbe.
44. The system of paragraph 43, wherein the light-detecting device comprises a light emitter and a light sensor.
45. The system of paragraph 44, wherein the light emitter is capable of emitting light in an infrared, visible or ultraviolet range.
46. The system of paragraph 43 or 44, wherein the light-detecting device comprises a photoelectric cell.
47. The system of any of paragraphs 43-46, further comprising a temperature sensor and a relative humidity sensor.
48. The system of any of paragraphs 43-47, further comprising a module for transmitting data.
49. A kit comprising a plurality of the test units of any of paragraphs 28-42, and an instruction manual.
50. The kit of paragraph 49, wherein the plurality of the test units are embodied in a continuous roll.
51. The kit of paragraph 49, wherein the plurality of the test units are discrete test units.
52. The kit of any of paragraphs 49-51, further comprising a portable light-detecting device.
53. The kit of paragraph 52, wherein the light-detecting device is a hand-held spectrometer.

### EXAMPLE

The example presented herein relates to one embodiment of the test unit, e.g., a test disc, and demonstrates the direct correlation between the concentration of microbial contamination, e.g., fungal contamination, and the amount of light emitted from a test disc infused with a conjugate of an enzyme substrate and detectable label. Throughout this application, various publications are referenced. The disclosures of all of the publications and those references cited within those publications in their entireties are hereby incorporated by reference into this application in order to more fully describe the state of the art to which this invention pertains. The following examples are not intended to limit the scope of the paragraphs to the invention, but are rather intended to be exemplary of certain embodiments. Any variations in the exemplified methods which occur to the skilled artisan are intended to fall within the scope of the present invention, and other embodiments are within the scope of the following claims.

### Example 1

The following example shows the direct correlation between the concentration of fungal contamination on a surface and the amount of light emitted from a test disc infused with a conjugate of a fungal enzyme substrate and 4-methylumbelliferone. Paper discs (0.5 cm2, Whatman, Ltd.) were soaked with 10 μl of 200 μM 4-methylumbelliferyl-N-acetyl-β-D-glucosaminide (MUF NAG) and allowed to dry. 5 μl volumes of fungal spore solutions (Aspergillus niger in H2O) of various concentrations were pipetted onto the paper discs. Each paper disc was immediately transferred to individual wells on a standard 96 well plate. The plate was incubated at 30° C. for 10 minutes in the dark. Fluorescence generated by each disc was measured with a Gemini XPS spectrofluorimeter. Three replicates were conducted for each concentration of spores and were averaged. The results, shown graphically in FIG. 2, show that the intensity of fluorescence emitted from each sample disc directly correlates with the concentration of fungal spores.

### REFERENCES

1. O'Brien M and RR Colwell, 1987 “A rapid test for chitinase activity that uses 4-methylumbelliferyl-N-acetyl-B-D-glucosaminide” Applied and Environmental Microbiology, 53:1718-1720.
2. Dealler SF, 1991 “Candida albicans colony identification in 5 minutes in a general microbiology laboratory” Journal of clinical microbiology, 29:1081-1082.
3. Freydiere A and R Guinet, 1997 “Rapid methods for identification of the most frequent clinical yeasts” Revista Iberoamericana de Micologia, 14:85-89.
4. Miller M and M Reeslev, 2002 “Method of selectively determining a fungal biomass” U.S. Pat. No. 6,372,446 B1.
5. Eden et al., 1994 “Dry slide for diagnostic tests” European Patent Application No. 0617282 A2.
6. Thompson, 1992 “Diagnostic Test Slide” U.S. Pat. No. 5,096,668.
7. Desphande et al., (1984), Ann. Biochem., vol. 138, 481-87.
8. Miller et al., U.S. Pat. No. 6,372,446 B1
9. Boschker and Cappenberg, (1994), Appl. Envir. Microbiol., vol. 60(10), pp. 3592-96.

It is understood that the foregoing detailed description and examples are illustrative only and are not to be taken as limitations upon the scope of the invention. Various changes and modifications to the disclosed embodiments, which will be apparent to those of skill in the art, may be made without departing from the spirit and scope of the present invention. Further, all patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

1. A method for determining presence or absence of a microbe, comprising the steps of:
(a) contacting a solid sample surface to be detected with a test unit comprising a base support having disposed thereon (i) at least one test area containing one or more targeting molecules comprising a microbial enzyme substrate conjugated to a detectable label, wherein the detectable label becomes released from the microbial enzyme substrate and unconjugated in the presence of a microbe, and (ii) at least one control area containing at least one known amount of the detectable label in an unconjugated state, and
(b) detecting a signal emitted from the unconjugated detectable labels in the test and control areas of the test unit, wherein a comparison of the signal emitted from the test area and the control area indicates the presence or absence of a microbe.

2. (canceled)

3. (canceled)

4. (canceled)

5. The method of claim 1, wherein the contacting is in situ.

6. The method of claim 1, wherein the method requires no suspension of the sample in a fluid prior to step (a), no addition of a reagent to the test unit prior to or after step (a), no culturing of a microbe collected from the sample surface prior to step (a), or any combinations thereof.

7. (canceled)

8. (canceled)

9. The method of claim 1, wherein the signal to be detected in step (b) is a light with a wavelength selected from an infra-red, visible or ultraviolet range.

10. (canceled)

11. (canceled)

12. (canceled)

13. The method of claim 1, further comprising comparing the signal of the test area with the signal of the control area to determine the amount of a microbe.

14. The method of claim 1, wherein the microbial enzyme substrate is N-acetyl-β-D-glucosaminide, N-acetyl-β-D-glucosamine, N,N′-diacetyl-β-D-chitobioside, β-D-N,N′,N″-triacetylchitotriose, or any combinations thereof.

15. The method of claim 1, wherein the detectable label is a chemiluminescent, chromogenic or fluorescent compound.

16. The method of claim 15, wherein the fluorescent compound is 4-methyl-umbelliferone.

17. The method of claim 1, wherein the at least one test area comprises at least two different targeting molecules comprising a microbial enzyme substrate conjugated with a detectable label.

18. (canceled)

19. (canceled)

20. (canceled)

21. The method of claim 1, wherein the at least one control area comprises a plurality of sub-areas each containing a known amount of the detectable label.

22. (canceled)

23. (canceled)

24. The method of claim 1, wherein the test unit further comprises an identification element disposed thereon.

25. (canceled)

26. (canceled)

27. The method of claim 1, wherein the microbe is selected from fungi, bacteria or a combination thereof.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A non-fluidic system for determining presence or absence, or an amount of a microbe in a sample comprising:
(a) a sample module configured to receive at least one test unit to be contacted with a sample, wherein said at least one test unit comprises a base support having disposed thereon (i) at least one test area containing one or more targeting molecules comprising a microbial enzyme substrate conjugated with a detectable label, wherein the detectable label becomes released from the microbial enzyme substrate and unconjugated in the presence of a microbe, and (ii) at least one control area containing at least one known amount of the detectable label in an unconjugated state;
(b) a light-detecting device configured to detect light emitted from the test and control areas;
(c) a computing module adapted to compare the light emission data of the test area with that of the control area; and
(d) a display module for displaying an output from the computing module, wherein the output indicates the presence or absence, or an amount of the microbe in the sample.

44. The system of claim 43, wherein the light-detecting device comprises a light emitter and a light sensor.

45. The system of claim 44, wherein the light emitter is capable of emitting light in an infrared, visible or ultraviolet range.

46. The system of claim 43, wherein the light-detecting device comprises a photoelectric cell.

47. The system of claim 43, further comprising a temperature sensor, a relative humidity sensor, or a combination thereof.

48. (canceled)

49. (canceled)

50. (canceled)

51. (canceled)

52. (canceled)

53. (canceled)

54. The method of claim 16, wherein at least one of the targeting molecules comprises 4-methyl-umbelliferyl-N-acetyl-β-D-glucosaminide.

55. The method of claim 1, wherein the solid sample surface is selected from the group consisting of a surface in a building, a surface of a medical device, an agricultural or food product, an harvested product, and a cultural heritage material.

56. The method of claim 1, wherein the solid sample surface is a biological tissue sample.
